(19) United States
(12) Patent Application Publication
(10) Pub. No.: US 2008/0272562 A1
(43) Pub. Date: Nov. 6, 2008

(54) Height Adjustment System for a Vehicle

(75) Inventors: Mats Sabelstrom, Billdal (SE); Christian Oscarsson, Myggenas (SE); Yngve Hagberg, Goteborg (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 11/915,380

(22) PCT Filed: Jun. 14, 2006
(86) PCT No.: PCT/SE06/00728

§ 371 Date: Nov. 24, 2007

(30) Foreign Application Priority Data
Jun. 17, 2005 (SE) 0501432-9

(51) Int. Cl. B60G 17/017

(52) U.S. Cl. 280/6.153

(57) ABSTRACT

A system for adjusting the chassis height and/or tilt of a motor vehicle including a plurality of chassis height adjusting devices includes a combination instrument comprising a display and a menu system defining an interface between an operator and the height adjusting devices. The chassis height and/or tilt is adjusted in response to an input provided by the operator. A motor vehicle including such a system is also disclosed.

### BACKGROUND AND SUMMARY

The present invention relates to a height adjustment system for vehicles with air suspension control.

The suspension system of a motor vehicle with air suspension can normally be used to adjust the vehicle's height. This possibility may be used to optimise the driving characteristics of the vehicle according to the actual driving conditions. It is e.g. advantageous to have a lower vehicle when driving on motorways than when driving on uneven roads. For a vehicle delivering goods, it will furthermore be relevant to adjust the height and/or the tilt angle of the vehicle to correspond to different loading ramps when loading and unloading goods.

The height adjustment on known vehicles is done with a control box, either wired or wireless. The driver will normally stand beside the vehicle with the control box in the hand and adjust the height of the vehicle or of an axle or axle pair, hi this way, the proper height and/or tilt of the vehicle can easily be adjusted to fit a loading ramp. The vehicle can have two adjustment ranges, one with a large adjustment range used for load handling when marshalling and one with a narrow adjustment range used when driving. The speed of the vehicle can be used to select between the different adjustment ranges.

One problem with a remote control box is that it can break or disappear. A wireless remote control box can be forgotten and left behind when the vehicle is driven away. A wired remote control box may be damaged and thus unoperational. The wireless remote control is, for safety reasons, programmed to work with the specific vehicle only, which means that a spare remote control may be cumbersome to obtain and to install. A new wired remote control is probably easier to find, but will still take time and money to replace.

The layout of the remote control box also limits the possible adjustments that can be made in order to make it robust, small and easy to use. In a known height control system, the driving height of the vehicle and the marshalling height of the vehicle, of the front or of the rear axle can be adjusted. There is also a possibility to save three preferred settings in a memory.

It is desirable to provide a stationary height adjustment system for a vehicle that is flexible, intuitive and reliable. Hereby it is possible to adjust the height of the vehicle to correspond to the height of e.g. a specific loading ramp, whereby the loading and unloading of the vehicle is made as easy as possible.

The present invention relates in a first aspect to a system for adjusting the chassis height and/or tilt of a motor vehicle comprising a plurality of chassis height adjusting devices, said system comprising: a combination instrument comprising a display and a menu system defining an interface between an operator and the height adjusting devices, input means for receiving input relating to an adjustment of the chassis height and/or tilt from an operator, said height adjusting devices being operationally connected to the input means for adjusting the chassis height and/or tilt in response to the input provided by the operator.

The input means may e.g. be a keypad, and this may be combined with a wireless or wired remote control. Thus, the system can be controlled by using only the keypad, by using the keypad in combination with a remote control and by using only a remote control. Regardless of the used input means, information of the present chassis height and/or tilt can be read in the display in the combination instrument.

There will typically be one or two adjusting devices associated with each axle of the vehicle, but any number will be possible within the scope of the invention. Furthermore, the position of the adjusting devices may be the same or differ between the axles. The adjusting devices may be adjusted individually, in pairs on in any other combination appropriate for the actual vehicle. In an embodiment of an aspect of the invention having two or more adjusting devices per axle, the adjusting devices associated with a given axle may have to be adjusted together. In another embodiment of an aspect of the invention it maybe possible to adjust the two or more adjusting devices associated with a given axle individually. Hereby it may be possible to take uneven loading into account and to adjust the rear of the vehicle to an uneven loading ramp.

The display may provide a visual indication of the adjustment of at least the chassis height and/or tilt. The display may furthermore show information about the position for each adjusting device. Hereby it may be possible for the operator of the system, typically the driver, to make use of knowledge about relationships between the position of the adjusting devices and the actual height and/or tilt of the chassis. The display may e.g. be a graphical user interface.

In an embodiment of an aspect of the invention, the system further comprises one or more sensors operationally connected to the display for providing an indication of the actual chassis height and/or tilt to the display. This will make it easier for the operator to operate the system without the need to leave the vehicle to check whether an actual adjustment is satisfactory.

The interface between the operator and the height adjusting devices preferably comprises a menu system. In one embodiment of an aspect of the invention this is obtained by adding a menu with submenus for the height adjustment to the present menu system. Hereby it may be possible to obtain a cheap solution that does not create any significant extra cost. It will furthermore be easy to update the interface to correspond to the actual vehicle. This may be done both during design and manufacturing of a new vehicle and at a later stage e.g. if changes are made to any part of the vehicle, such as if a new type of adjustment device is incorporated.

In an embodiment of an aspect of the invention all possible adjustments may be organised in one main menu having a number of sub-menus. A possible procedure may be to first adjust the height of the whole chassis to a value as close as possible to the desired one and then fine-tune the height by tilting the chassis. Another possibility may be to adjust the tilt only, if that is enough with the actual chassis height.

The system may further comprise a database and processor means for data-look-up in the database. This may e.g. make it possible for the operator to choose between a number of predefined chassis heights and/or tilts. These maybe selectable e.g. in steps of a predefined measure, such as 20 or 50 mm, or they may be defined to correspond to the most often needed loading or unloading heights. It may also be a combination of these possibilities. Still another possibility may be that the adjustment of the chassis height can take place infinitely variably or at least in very small steps.

Instead of or in addition to these features, it may be possible for the operator to choose between a number of locations described by a customer name, a geographical name, a specific loading ramp or the like, each having a predefined chassis height and/or tilt assigned. In this case the system may or may not be able to compensate for the loading of the vehicle.

The system may further comprise image-displaying means showing information from a camera placed to monitor the rear of the vehicle. This may significantly improve the adjustment procedure especially when the system does not comprise the possibility of choosing between a number of locations as described above. The image displaying means may be integrated in the dashboard display of the vehicle, or they may comprise a separate display, such as a television screen. This is also advantageous when the system is operated without an optional remote control.

In a preferred embodiment of an aspect of the invention, the chassis height adjusting devices are part of the suspension system of the vehicle. The system is preferably used for vehicles with air suspension in the form of air bellows. The height adjustment may then involve varying the volume of one or more of the air bellows. In another embodiment of an aspect of the invention, the chassis height adjusting devices may comprise pneumatic or hydraulic cylinders. This may be possible both when the suspension system is an air suspension system and when it is another type of system, such as comprising coil or leaf springs.

In a preferred embodiment of an aspect of the invention, the system is combined with a position sensing system, e.g. GPS. This allows for an automatic recognition of the present location of the vehicle. By using this information, the height of the vehicle can be automatically adjusted to correspond to a loading ramp at this location.

The present invention relates in a second aspect to a motor vehicle having a system as described above. The vehicle preferably comprises a plurality of height adjusting devices for adjusting the chassis height and/or tilt, said devices being controlled via a menu system in the combination instrument of the vehicle.

### BRIEF DESCRIPTION OF THE FIGURES

In the following, preferred embodiments of the present invention will be described with reference to the accompanying figures in which:

FIGS. 1-2 illustrate an embodiment of a system for adjusting the chassis height and/or tilt according to an aspect of the invention, and

FIGS. 3-5 illustrates schematically an adjustment of the loading height by changing the chassis height and tilt, respectively, of a vehicle parked at a loading ramp.

### DETAILED DESCRIPTION

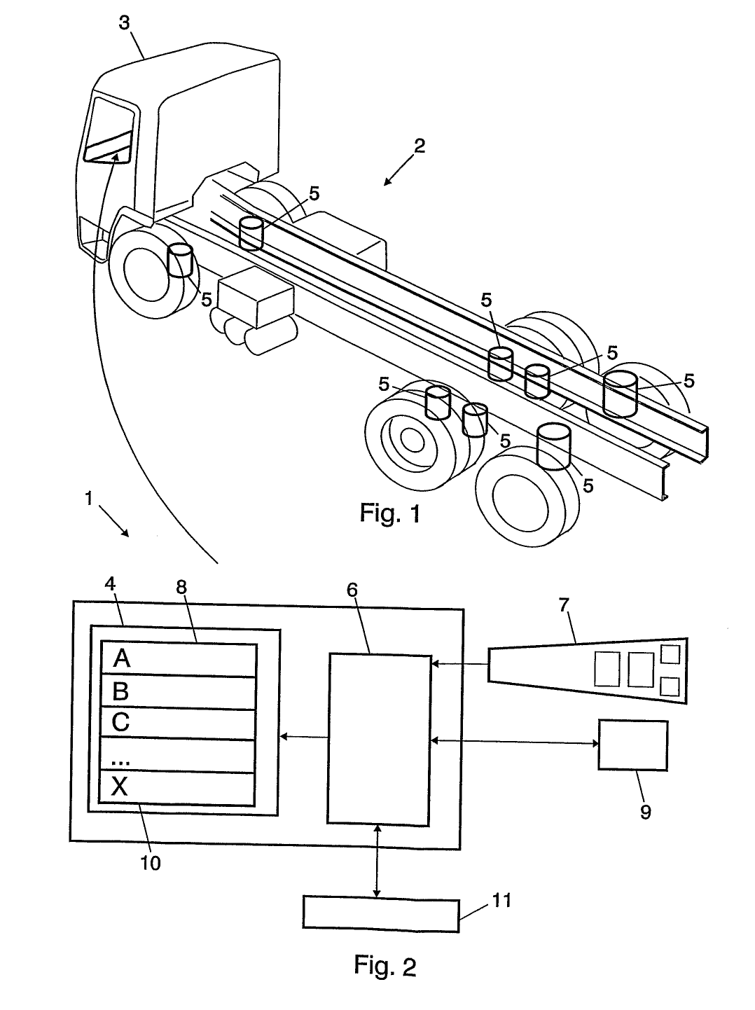

FIGS. 1-2 illustrates a preferred embodiment of the present invention in which it is possible to adjust the air suspension settings of the vehicle, i.e. the chassis height and/or tilt, without the use of a remote control unit. The communication between the operator, typically the driver, and the suspension control system takes place via the combination instrument 1 comprising a display 4 and a control unit 6 integrated in the combination instrument. The combination instrument is sometimes referred to as the instrument cluster. The combination instrument is a unit on the vehicle where information that relates to the vehicle and the driving of the vehicle is displayed. A typical combination instrument for a heavy vehicle comprises pointer instruments that displays for example the speed, engine speed, brake pressure, engine temperature, etc., various control lamps, for example indicators, full-beam headlights, etc., and some kind of trip computer. The combination instrument is connected to other control units 9 on the vehicle by a data bus. The combination instrument also comprises a menu system 8.

An input unit with a keypad 7 is connected to the control unit 6. The display 4 is used to display information of various types, for example status messages, error messages and time. It is also used to make settings via the menu system 8 using different menus. The control unit 6 contains software and logic circuits that control the instrument. The control unit 6 also receives information from the vehicle's other control units 9 via a data bus on which information from the combination instrument is also transmitted. The keypad 7 here consists of four switches that are used to navigate the menu system. The switches represent the functions “Enter”, “Escape”, “Up” and “Down”. The keypad 7 is located on the vehicle's windshield wiper arm.

To select a function in the menu system, the switches “Up” and “Down” are used to find the desired menu. This menu is then selected using “Enter”. For each menu, there can be several submenus where various settings and selections can be made. For example, the time can be set or the operator can see the calculated remaining driving distance. When a setting or selection has been carried out, the operator goes back to the preceding menu using “Escape”.

The menu system 8 comprises a height adjusting menu 10. The control unit 6 comprises a control output that is directly connected to the ECS system 11 (ECS=Electronic Controlled Suspension). The control unit can also communicate with the ECS system via the data bus. The ECS system controls the air bellows 5 in order to adjust the height of the vehicle or of individual axles. The ECS system is also equipped with height measuring means for measuring the present height of an axle or axle pair. The height measuring means is often a potentiometer positioned on the chassis operated by a linkage connected to the axle, hi this way, the change in height can be detected and this value is used to calculate the chassis height.

FIG. 1 shows a conventional truck 2 having chassis and a driver's cab 3. The truck comprises a plurality of height adjusting air bellows 5 for adjusting the vehicle's height, that is, the chassis height and/or tilt. The vehicle can either have air bellows on the rear axle or axles or, as in this example, have air bellows on both the front and rear axles.

FIG. 2 shows the system according to an aspect of the invention integrated in the combination instrument 1 in the cab 3 of the truck 2 shown in FIG. 1. According to an aspect of the invention, the system has a chassis height and tilt adjustment menu 10 for controlling the air bellows 5 on the vehicle. The height adjustment menu 10 is selected in the menu system 8 as described above.

A number of settings can be carried out in the height adjustment menu 10, for example raising or lowering the chassis, and, in addition, one or more submenus can be selected. In the menu 10, the values of different chassis settings can be read, for example settings referring to predefined locations described by a customer name, a geographical name, a specific loading ramp or the like, each having a predefined chassis height and/or tilt assigned.

Preferably, when reaching menu 10, a schematic vehicle is shown in the display 4 such that the operator gets a graphical view of the vehicle preferably including the present settings of the air bellows 5, i.e. the adjustment of the chassis height and tilt. The result can be presented as e.g. the distance from the ground to the upper part of the chassis at each axle, i.e. the axle height. The result can be presented in a metric value.

At the same time, the most relevant values are displayed in the menu. This can e.g. include the chassis height and tilt angle for the vehicle. In this menu, it may be possible to adjust the height of the vehicle by simply pushing the “Up” or “Down” button. The size of the increment may be selected or fixed and may be performed in steps or continuously when the button is pressed down. If the vehicle is driving on the road, the adjustment is limited to the driving adjustment range, and when the vehicle is marshalling, the full adjustment range is possible to use. The adjustment range is preferably indicated in the menu.

In the menu, it is also possible to select a sub-menu in which more specific adjustments may be performed. This may involve the adjustment of a single axle, the vehicle tilt or other settings.

In another sub-menu, it is possible to select between a number of predefined settings stored in a memory. Each setting may e.g. correspond to a specific location, hi this embodiment, the system comprises the option of pre-programming the system to contain data on interrelated values for location and chassis height and to retrieve the stored information. The location may e.g. be described by the name of the corresponding customer or any other type of easily identifying information. The easiest way of pre-programming a setting is to save a setting at the actual location. When the vehicle is adjusted to dock e.g. a loading ramp, the actual settings are stored in the memory under a specific number or name. This number or name can later easily be recalled from the memory when the vehicle is at or near the same location, hi this way, the driver can save some time at each location, because he/she do not have to do the adjustments when the vehicle is parked. Instead, the adjustments are already done when the vehicle stops.

In an embodiment of an aspect of the invention, the selection of location settings maybe integrated with a GPS-system. By doing this, the position of the location can be stored together with the settings in the memory. When the vehicle reaches a specific location, i.e. a specific position, the system recognises the position and automatically selects the settings corresponding to that position.

In a further embodiment, the system also comprises a handheld remote control unit. With this remote control unit, it is also possible to adjust the height of the vehicle. With the remote control, it is easy to adjust a vehicle at a new loading ramp, since the driver can stand outside the vehicle within sight of the loading ramp. After the adjustments are ready, the settings can be saved in a memory.

In a further embodiment, the settings in the memory of a vehicle can be transferred to a database, e.g. at a central station of a company. This is advantageous for a larger distribution company or when replacing a truck. In this way, the settings can be used by all vehicles in a vehicle fleet or the settings can be transferred to a new vehicle when a vehicle is being replaced. Otherwise, each vehicle has to be adjusted at every location in order to save the settings in the memory.

In a further embodiment, the system also comprises a function that calculates the height of a device mounted on the vehicle. Such a device can e.g. be a tail lift or a fifth wheel. In this embodiment, the height of the rear end of the tail lift, when it is in a preferred folded down position, is used as the reference value for the adjustment of the vehicle height. If the height of the loading ramp is known, and the ground is relatively flat, this value can be used as the set value for the vehicle height. By adjusting the vehicle height to fit the tail lift before the tail lift is folded down will save time for the driver.

An embodiment of an aspect of the invention may comprise a database in which the information is stored on a medium that can be read by a computer system integrated in the control system. This medium can e.g. be a data diskette, a memory module, a CD or the like. Hereby the system can easily be updated and adjusted to the actual use of the vehicle. The updating of the software can also be carried out via a connection, e.g. via the Internet, to a server where the program is stored. It is furthermore advantageous to enable the operator to update the information when having the chassis adjusted to a given position by e.g. choosing a function that stores information of the actual settings into the system.

Additional information related thereto, such as the name of the customer, may preferably be entered at the same time, e.g. by means of a keypad. Alternatively it may have to be entered at a later stage.

In addition to the adjustment of the chassis height in order to ease loading and unloading of the vehicle, adjustments may also be desired to ensure good driving characteristics. For this purpose a limited number of settings are satisfactory. They may be selectable in the menu system as described above. The menu system provides a compact solution that can easily be updated if necessary, e.g. to be adapted to the actual vehicle. However, they may also be selectable from additional buttons on the dashboard, e.g. by having specific chassis heights assigned to specific keys. A two-position rocker switch corresponding to a high and a low driving position is one possibility. This solution provides a solution that may be easier to operate during driving thereby providing a safer driving solution.

The display may be designed to show at all times the current settings of the system. This is preferably done by a graphical representation, e.g. of the vehicle, but it may also be a listing of numerical values.

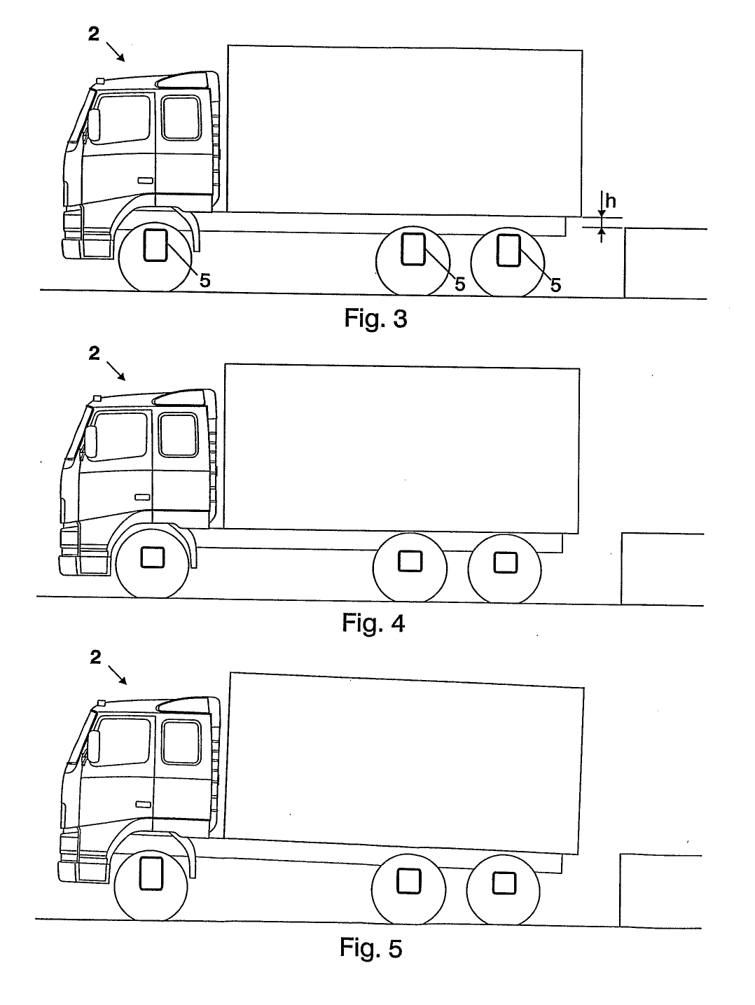

FIGS. 3-5 illustrates schematically a vehicle parked at a loading ramp. In FIG. 3, the loading and unloading is eased by lowering the whole vehicle by the distance marked as (h), thus obtaining the position shown in FIG. 4. A larger variation in loading and unloading height can be obtained by tilting the chassis as illustrated schematically in FIG. 5. Tilting the vehicle is also used to level the vehicle when the ground is uneven. The easiest way to adjust the vehicle height for the first time at a new loading ramp is to use a remote control. The remote control can be a wireless remote control or a wired remote control of the kind known to the person skilled in the art. When the vehicle is adjusted to the loading ramp in the desired manner, i.e. the vehicle height and tilt is adjusted, the settings are stored in a memory. In this way, the loading and unloading of the vehicle will be easier and safer for the driver, since a proper height and angle of the vehicle will lower the chance of injury, due to e.g. a too steep tail lift.

The vehicle adjustments shown in FIGS. 3-5 can be obtained e.g. by selecting them from the menu system as mentioned above (for example as a predefined setting for this particular ramp) or by manually entering the value for the chassis height and tilt.

The illustrations in FIGS. 3-5 may e.g. appear in the menu system when entering menu 10 of FIG. 1 or a sub-menu so that the operator can see a graphical view of the vehicle and the actual height adjustment on the display 4. When the operator changes the height adjustment, the display 4 may show the progress of the vehicle changing height or tilting.

The system may be further improved by mounting a camera at the rear of the vehicle which camera is connected to a display screen placed to aid the driver when adjusting the chassis height and tilt from inside the drivers cabin.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

1. A system for adjusting at least one of chassis height and tilt of a motor vehicle comprising a plurality of chassis height adjusting devices, the system being stationary within a vehicle, the system comprising:
a combination instrument comprising a display with a menu system defining an interface between an operator and the height adjusting devices, and
an input keypad connected to the display via a control unit for receiving input relating to an adjustment of at least one of the chassis height and tilt, the input keypad being operationally connectable to height adjusting devices for adjusting the at least one of the chassis height and tilt in response to the input provided.

2. A system according to claim 1, wherein the display provides a visual indication of adjustment of at least the at least one of the chassis height and tilt.

3. A system according to claim 1, further comprising a database and processor for data-look-up in the database.

4. A system according to claim 1, wherein an operator can input a number of predefined ones of at least one of the chassis height and tilt.

5. A system according to claim 4, wherein the operator can input a number of locations, each having a predefined one of at least one of the chassis height and tilt assigned.

6. A system according to claim 1, wherein the system further comprises a position sensing system for the detection of a location.

7. A system according to claim 6, wherein the system is adapted to automatically select a predefined one of at least one of the chassis height and tilt setting using the detected location as an input.

8. A system according to claim 1, wherein the system further comprises image-displaying means showing information from a camera placed to monitor the rear of the vehicle.

9. A motor vehicle having a system according to any of the preceding claims.

10. A system according to claim 2, further comprising a database and processor for data-look-up in the database.

11. A system according to claim 2, wherein an operator can input a number of predefined ones of at least one of the chassis height and tilt.

12. A system according to claim 11, wherein the operator can input a number of locations, each having a predefined one of at least one of the chassis height and tilt assigned.

13. A system according to claim 2, wherein the system further comprises a position sensing system for the detection of a location.

14. A system according to claim 13, wherein the system is adapted to automatically select a predefined one of at least one of the chassis height and tilt setting using the detected location as an input.

15. A system according to claim 2, wherein the system further comprises image-displaying means showing information from a camera placed to monitor the rear of the vehicle.
